(19) United States
(12) Patent Application Publication
(10) Pub. No.: US 2018/0193729 A1
(43) Pub. Date: Jul. 12, 2018

(54) SERVER BASED GAMING SYSTEM

(71) Applicant: Phillip Lennon, Bloomington, IN (US)

(72) Inventor: Phillip Lennon, Bloomington, IN (US)

(21) Appl. No.: 15/400,991

(22) Filed: Jan. 7, 2017

(51) Int. Cl. A63F 13/216; A63F 13/235; A63F 13/2145; A63F 13/46; A63F 13/65; A63F 13/837; A63F 13/847; A63F 13/35

(52) U.S. Cl. CPC A63F 13/216; A63F 13/235; A63F 13/2145; A63F 13/46; A63F 13/65; A63F 13/837; A63F 2300/69; A63F 13/35; A63F 2300/1031; A63F 2300/1075; A63F 2300/5533; A63F 2300/61; A63F 13/847

(57) ABSTRACT

The system comprises a memory unit to store a database comprising records associated with a plurality of user devices and a set of program modules. The system further comprises a processor to execute the set of program modules. A game controller module is configured to receive at least one name from the first user device. The game controller module is configured to alter the game status of at least one user device to dead, based on at least one name being identical to name of at least one user device. The game controller module is configured to receive an input signal from at least one user device. The game controller module is configured to alter a first game status associated with the first user device into one of dead and undead based on the input signal being received from at least one user device.

### BACKGROUND OF THE INVENTION

### A. Technical Field

The present invention generally relates to the technical field of gaming systems, and more specifically relates to a server based gaming system.

### B. Description of Related Art

Mobile game applications have pervaded every aspect of life in the twenty first century. Examples of the mobile game applications include but are not limited to Angry Birds, Star Wars, and Age of the Empires. Today, users access the mobile game applications for multiple purposes. Users access the mobile game applications for recreational purposes. Even though users find the mobile game applications entertaining, the mobile game application usage has an adverse effect on the amount of daily physical activity done by the players. There is a need for a mobile game application that encourages the users to increase the amount of their daily physical activity.

Therefore, there is a need in the art for a server based gaming system that encourages users to engage in physical activity.

### SUMMARY OF THE INVENTION

The present invention relates to a server based gaming system.

In one embodiment of the present invention, the system comprises a memory unit to store a database comprising one or more records associated with a plurality of user devices and a set of program modules. The one or more records comprises locations of the plurality of user devices, names of the plurality of user devices and a game status of a user associated with the plurality of user devices. The game status associated with the user is one of alive, dead and undead. The system further comprises a processor to execute the set of program modules. The set of program modules comprises an input module, executed by the processor, configured to receive a first location associated with a first user device among the plurality of devices. The set of program modules comprises a game controller module executed by the processor. The game controller module is configured to identify at least one user device in vicinity of the first user device. The game controller module is configured to notify the first user about the presence of at least one user in the vicinity, based on the game status associated with at least one user device being undead. The game controller module is configured to receive at least one name from the first user device. The game controller module is configured to alter the game status of at least one user device to dead, based on at least one name being identical to the name of at least one user device. The game controller module is configured to receive an input signal from at least one user device. The game controller module is configured to alter a first game status associated with the first user device into one of dead and undead based on the input signal being received from at least one user device.

In one embodiment of the present invention, the plurality of user devices comprises smart phones, laptops, and tablet computers. The plurality of user devices have at least one Bluetooth® id. Locations of the plurality of user devices are measured by means of Bluetooth® in the user device.

In one embodiment of the present invention, a computer implemented method of implementing a server based gaming system comprises storing in a memory unit a memory unit a database comprising one or more records associated with a plurality of user devices and a set of program modules. The one or more records comprises locations of the plurality of user devices, names of the plurality of user devices and game statuses of users associated with the plurality of user devices. The game status associated with a user is one of alive, dead and undead. The method comprises receiving at a processor via an input module, a first location associated with a first user device among the plurality of devices. The method comprises identifying at the processor via a game control module, at least one user device in the vicinity of the first user device. The method comprises notifying, by the processor via the game control module, the first user about presence of at least one user in the vicinity, based on the game status associated with at least one user device being undead. The method comprises receiving, by the processor via the game control module, at least one name from the first user device. The method comprises altering, by the processor via the game control module, the game status of at least one user device to dead, based on at least one name being identical to name of at least one user device. The method comprises receiving, by the processor via the game control module, an input signal from at least one user device. The method comprises altering, by the processor via the game control module, a first game status associated with the first user device into one of dead and undead based on the input signal being received from at least one user device.

### BRIEF DESCRIPTION OF DRAWINGS

FIG. 1 is a block diagram of an environment implemented in accordance with various embodiments of the invention.

FIG. 2 is a block diagram of a server based gaming system in accordance with various embodiments of the invention.

FIG. 3 is flow chart of a computer-implemented method of implementing a server based gaming system, according to yet another embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

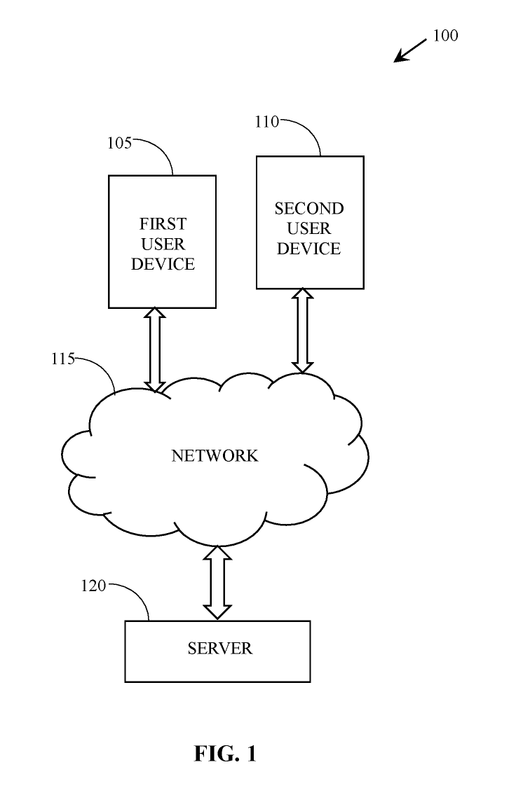

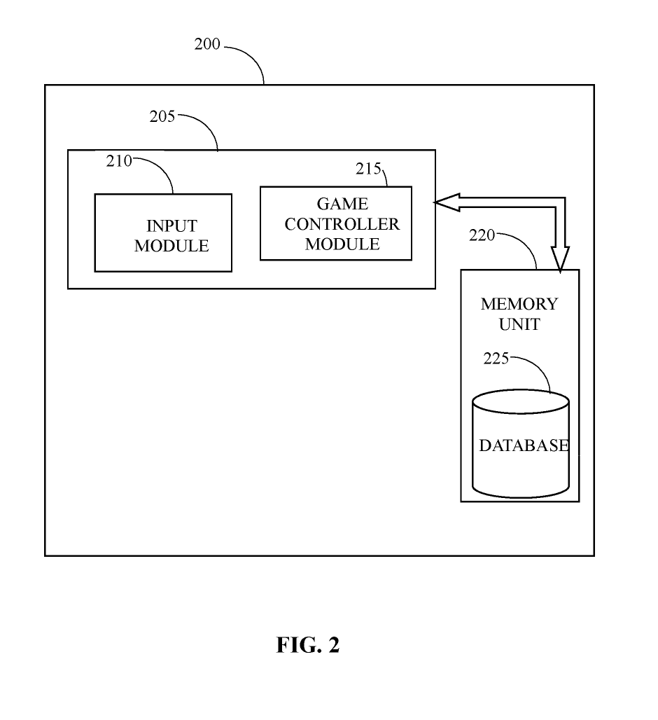

FIG. 1 is a block diagram of an environment 100 wherein various embodiments of the invention are implemented. The environment 100 comprises a first user device 105, a second user device 110, a network 115, and a server 120. Examples of the first user device 105 and the second user device 110 comprises at least one of a smart phone, a tablet computer, and a laptop. The network 115 is at least one of a Bluetooth® network, a Wifi network, and a wireless local area network. The first user device 105 and the second user device 110 communicates with the server 120 via the network 115. A block diagram of the server 120 is exemplarily illustrated in FIG. 2.

Referring to FIG. 2, a server 200 comprises a memory unit 220 to store a database 225 comprising one or more records associated with a plurality of user devices, and a set of program modules. The one or more records comprises locations of the plurality of user devices, names of the plurality of user devices and game statuses of users associated with the plurality of user devices. The plurality of user devices comprises smart phones, laptops, and tablet computers. The plurality of user devices have at least one Bluetooth® id. Locations of the plurality of user devices are measured by means of Bluetooth® range of the plurality of user device. The game status associated with a user is one of alive, dead and undead. The server 200 further comprises a processor 205 to execute the set of program modules. The set of program modules comprises an input module 210, executed by the processor 205, configured to receive a first location associated with a first user device among the plurality of devices. The set of program modules further comprises a game controller module 215, executed by the processor 205. The game controller module 215 is configured to identify at least one user device in the vicinity of the first user device. The game controller module 215 is further configured to notify the first user about the presence of at least one user in the vicinity, based on the game status associated with at least one user device being undead. The game controller module 215 is configured to receive at least one name from the first user device. The game controller module 215 is further configured to alter the game status of at least one user device to dead, based on at least one name being identical to name of at least one user device. The game controller module 215 is further configured to receive an input signal from at least one user device. The game controller module 215 is further configured to alter a first game status associated with the first user device into one of dead and undead based on the input signal being received from at least one user device.

In one example, the present invention is implemented as a mobile application running on the server 200 and the plurality of user devices. Hereafter, a user device with game status as “undead” is referred to as “Zombie”. Further, the user device with game status as “alive” is referred to as survivor. If the Zombie alters game status of the survivor, then the zombie is said to have “infected the survivor”. The game controller module 215 tracks each of the plurality of user devices and allows a Zombie to infect a survivor. Further, the game controller module 215 enables the survivor to alter game status of the zombie to “dead” depending on the zombie and the survivor being in the same vicinity of each other. The game controller module 215 allows users associated with the plurality of user devices to recognize one another and provides proximity alarm to the survivor to take actions if the zombie is in vicinity of the survivor. However, the game controller module 215 does not provide information regarding location of the zombie to the survivor. The game controller module 215 will monitor multiple games simultaneously. The survivor is enabled to protect themself either by one of vacating the vicinity of the zombie and by altering game status of the zombie to “dead.” If the survivor mistakenly shoots another survivor instead of a zombie, the survivor shall lose scores. In order to infect the survivor, the zombie has to be in close proximity to the survivor. The zombie is enabled to infect the survivor by pressing an activation button on the user device associated with the zombie. The survivor will be deemed as a slowly decomposing zombie after the infection.

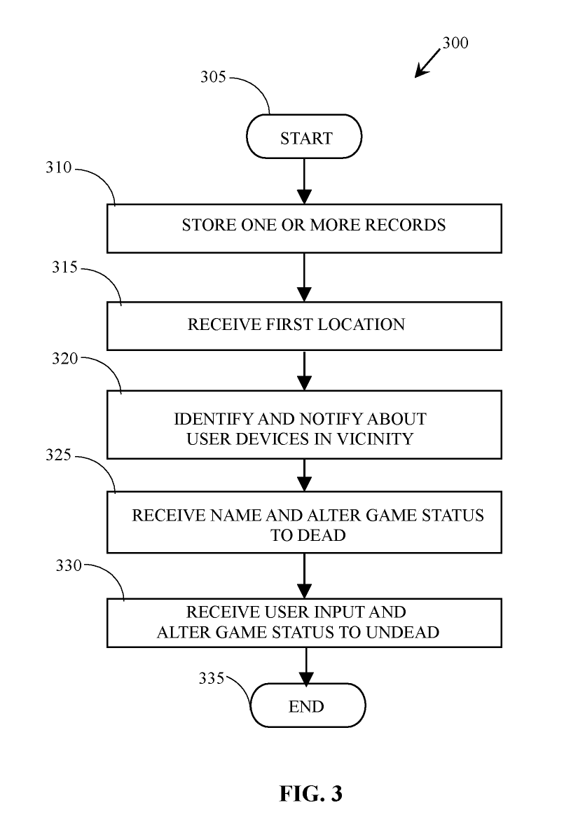

FIG. 3 is a flowchart of a method 300 of implementing a server based gaming system in accordance with an embodiment of the present invention. In one example, the method 300 is implemented inside a server connected to a network (not shown). The method 300 begins at step 305. The server comprises a memory unit to store a database.

At step 310, the memory unit stores one or more records associated with a plurality of user devices and a set of program modules. The one or more records comprises locations of the plurality of user devices, names of the plurality of user devices and game statuses of users associated with the plurality of user devices. The plurality of user devices comprises smart phones, laptops, and tablet computers. The plurality of user devices have at least one Bluetooth® id. Locations of the plurality of user devices are measured by means of Bluetooth® range of the plurality of user device. A game status associated with a user is one of alive, dead and undead. The system further comprises a processor to execute the set of program modules.

At step 315, the processor via an input module receives a first location associated with a first user device among the plurality of devices. The set of program modules further comprises a game controller module, executed by the processor.

At step 320, the game controller module identifies at least one user device in the vicinity of the first user device. The game controller module further notifies the first user about the presence of at least one user in the vicinity, based on the game status associated with at least one user device being undead. The game controller module is further configured to receive at least one name from the first user device.

At step 325, the game controller module alters the game status of at least one user device to dead, based on at least one name being identical to the name of at least one user device.

At step 330, the game controller module further receives an input signal from at least one user device. The game controller module alters a first game status associated with the first user device into one of dead and undead based on the input signal being received from at least one user device. In one example, the present invention is implemented as a mobile application running on the server and the plurality of user devices. Hereafter, a user device with game status as “undead” is referred to as “Zombie.” Further, the user device with game status as “alive” is referred to as “Survivor.” If the Zombie alters the game status of the survivor, then the zombie is said to have “infected the survivor.” The game controller module tracks each of the plurality of user devices and allows a Zombie to infect a survivor. Further, the game controller module enables the survivor to alter the game status of the zombie to “dead” depending on the zombie and the survivor being in the same vicinity of each other. The game controller module allows users associated with the plurality of user devices to recognize one another and provides proximity alarm to the survivor to take actions if the zombie is in vicinity of the survivor. However, the game controller module does not provide information regarding location of the zombie to the survivor. The game controller module will monitor multiple games simultaneously. The survivor is enabled to protect himself either by one of vacating the vicinity of the zombie and by altering game status of the zombie to “dead.” If the survivor mistakenly shoots another survivor instead of a zombie, the survivor shall lose scores. In order to infect the survivor, the zombie has to be in close proximity to the survivor. The zombie is enabled to infect the survivor by pressing an activation button on the user device associated with the zombie. The survivor will be deemed as a slowly decomposing zombie after the infection.

The method 300 ends at step 335.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A server based gaming system, the system comprising:
a memory unit to store:
a database comprising one or more records associated with a plurality of user devices, and
a set of program modules,
wherein the one or more records comprises locations of the plurality of user devices, names of the plurality of user devices and a game status of a user associated with the plurality of user devices, and wherein the game status is one of alive, dead and undead; and
a processor to execute the set of program modules, wherein the set of program modules comprise:
an input module, executed by the processor, configured to:
receive a first location associated with a first user device among the plurality of devices;
a game controller module, executed by the processor, configured to:
identify at least one user device in vicinity of the first user device,
notify the first user about presence of at least one user in the vicinity, based on the game status associated with at least one user device being undead,
receive at least one name from the first user device,
altering the game status of at least one user device to dead, based on at least one name being identical to name of at least one user device,
receive an input signal from at least one user device,
altering a first game status associated with the first user device into one of dead and undead based on the input signal being received from at least one user device.

2. The system of claim 1, wherein the plurality of user devices comprises smart phones, laptops, and tablet computers.

3. The system of claim 2, wherein the plurality of user devices have at least one Bluetooth® id.

4. The system of claim 2, wherein locations of the plurality of user devices are measured by means of Bluetooth® range of the plurality of user device.

5. A method of implementing a server based game comprising:
storing in a memory unit, a database comprising one or more records associated with a plurality of user devices, and a set of program modules, wherein the one or more records comprises locations of the plurality of user devices, names of the plurality of user devices and a game status of a user associated with the plurality of user devices, and wherein the game status is one of alive, dead and undead;
receiving at a processor via an input module, a first location associated with a first user device among the plurality of devices;
identifying at the processor via a game control module, at least one user device in vicinity of the first user device;
notifying, by the processor via the game control module, the first user about presence of at least one user in the vicinity, based on the game status associated with at least one user device being undead;
receiving, by the processor via the game control module, at least one name from the first user device;
altering, by the processor via the game control module, the game status of at least one user device to dead, based on at least one name being identical to name of at least one user device,
receiving, by the processor via the game control module, an input signal from at least one user device,
altering, by the processor via the game control module, a first game status associated with the first user device into undead based on the input signal being received from at least one user device.

6. The method of claim 5, wherein the plurality of user devices comprises smart phones, laptops and tablet computers.

7. The method of claim 6, wherein the plurality of user devices have at least one Bluetooth® id.

8. The method of claim 7, wherein locations of the plurality of user devices are measured by means of Bluetooth® range of the plurality of user device.
